(19) United States
(12) Patent Application Publication
(10) Pub. No.: US 2009/0087115 A1
(43) Pub. Date: Apr. 2, 2009

(54) CORRECTION FOR GEOMETRIC DISTORTION IN IMAGES IN PIPELINED HARDWARE

(76) Inventors: Ping Wah Wong, Sunnyvale, CA (US); Clement K.L. Ip, Saratoga, CA (US)

Correspondence Address: HAHN AND MOODLEY, LLP, P.O. BOX 52050, MINNEAPOLIS, MN, 55402, US

(21) Appl. No.: 11/866,342

(22) Filed: Oct. 2, 2007

(51) Int. Cl. G06K 9/40; G06K 9/54

(52) U.S. Cl. 382/255; 382/303

(57) ABSTRACT

In one embodiment, method for correcting geometric distortion in an image is provided. The method comprises operating at least first and second buffers upstream of a pixel processing block in pipelined hardware to each read M×N pixels of an input image to be corrected for geometric distortion; selectively connecting one of the first and second buffers to the pixel processing block for inputting the M×N pixels contained therein to the pixel processing block; and in the pixel processing block, processing the M×N input pixels to correct for geometric distortion, the processing block being configured to output segments 1×L pixels wide of an output image that is corrected for geometric distortion; wherein values for M and N are selected to define a minimum block size in the input image required to produce each current 1×L segment in the output image by an algorithm to correct for geometric distortion in the input image.

### FIELD

Embodiments of the invention relate to image processing.

### BACKGROUND

Images and video sequences captured in a digital imaging system can exhibit geometric distortion caused by, e.g., the optics. Common geometric distortion can include barrel distortion, pincushion distortion, fish-eye distortion, spherical distortion, and chromatic aberration. FIG. 1 shows barrel and pincushion distortions.

FIG. 2 shows an example of a digital image capturing system 200 comprising an image sensing device 202 coupled to an image signal processor 204. The image signal processor 204 comprises a collection of image processing algorithms 206, an image scalar 208, and a block 210 for correcting geometric distortion. The system 200 also includes an output display or storage device 212. Typical image processing algorithms found in the system can include demosaicing, color correction, smoothing, sharpening, . . . etc. The image scalar 208 changes the size of the image to the desired size for display or storage. For example, the image sensing device 202 may generate 3 million pixels, whereas the output display is at 307 thousand pixels (640×480 size). In typical image capturing systems, image data from the sensing device is produced and sent to the image processing blocks at a constant data rate. Hence the change in image size at the scalar implies that the data rates at the input and output of the scalar are different.

Consider an input pixel a(x_{d}, y_{d}) where (x_{d}, y_{d}) is the spatial coordinates of a geometrically distorted image. Let (x_{c}, y_{c}) be the coordinates of the “lens center”. The lens center may or may not coincide with the geometric center position of the two-dimensional image array. Expressing in polar coordinates, the radius and angle of the pixel location (x_{d}, y_{d}) from the center of the lens are

r_{d}=\sqrt{(x_{d}−x_{c})²+(y_{d}−y_{c})²}

θ_{d}=arctan((y_{d}−y_{c})/(x_{d}−x_{c})) (1)

Generally, any geometric distortion can be modeled in polar coordinates as

rᵤ=f(r_{d},θ_{d})

θᵤ=g(r_{d},θ_{d}) (2)

where f( ) and g( ) are functions of two variables, and the subscripts d and u represent the coordinates of the distorted and undistorted images, respectively. The relationship between (rᵤ, θᵤ) and the Cartesian coordinates (xᵤ, yᵤ) is similar to (1) with the obvious change of subscripts. Both barrel distortion and pincushion distortion can be represented by a model

rᵤ=r_{d}(1+λr_{d}²)=r_{d}+λr_{d}³

θᵤ=θ_{d} (3)

where λ is a parameter. The problem of correcting for geometric distortion is equivalent to finding the pixel in an input image a(x_{d}, y_{d}) that corresponds to pixel locations in an undistorted output image b(xᵤ, yᵤ). Specifically, we can let

b(xᵤ, yᵤ)=a(x_{d}, y_{d}) (4)

where the distorted and undistorted coordinates are related by (3). In the case that (x_{d}, y_{d}) does not fall exactly on a grid point of the input image, interpolation from the neighboring pixels to obtain b(xᵤ, yᵤ) can be performed.

One technique for correcting geometric distortion in images uses the rendering capabilities of a graphics processing unit (GRU). Specifically the technique tessellates the distorted image into a set of triangles. The vertexes of the triangles in the distorted image are mapped using (3) to vertex coordinates in the undistorted image. The GRU renders the undistorted output image by interpolating the pixel values between the mapped vertexes. The usage of triangles introduces additional distortion compared to a method of direct calculation using (4).

Another technique for correcting geometric distortion calculates the output pixels from (4) using bilinear interpolation with 4 neighboring pixels. As a result, the interpolator must fetch 4 input pixel values for the interpolator for every output pixel b(xᵤ, yᵤ). If the input image is stored in a frame memory buffer, address set up time for memory must be allowed before fetching the 4 required input pixel values. This technique reduces data fetching by reducing the number of input pixels used for interpolation depending on the configuration when moving from one pixel location to the next. This will impact the quality of the output image.

Generally a geometric correction method would store the input image in a frame buffer, and then suitable input pixels are fetched for calculating the output as given by (4). To fetch the input pixels from memory, it is necessary to accommodate for memory address set up time and memory read time. Hence the required clock speed for reading data from the frame buffer will be many times the clock speed for sending the output image. This causes a problem for hardware pipeline implementations because the number of image frames going through the pipeline must be a constant. This is referred to as a memory bandwidth problem.

### SUMMARY

In one embodiment, method for correcting geometric distortion in an image is provided. The method comprises operating at least first and second buffers upstream of a pixel processing block in pipelined hardware to each read M×N pixels of an input image to be corrected for geometric distortion; selectively connecting one of the first and second buffers to the pixel processing block for inputting the M×N pixels contained therein to the pixel processing block; and in the pixel processing block, processing the M×N input pixels to correct for geometric distortion, the processing block being configured to output segments 1×L pixels wide of an output image that is corrected for geometric distortion; wherein values for M and N are selected to define a minimum block size in the input image required to produce each current 1×L segment in the output image by an algorithm to correct for geometric distortion in the input image.

Other aspects of the present invention will become apparent from the detailed description below.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings, wherein:

FIG. 1 illustrates barrel and pincushion distortion in images.

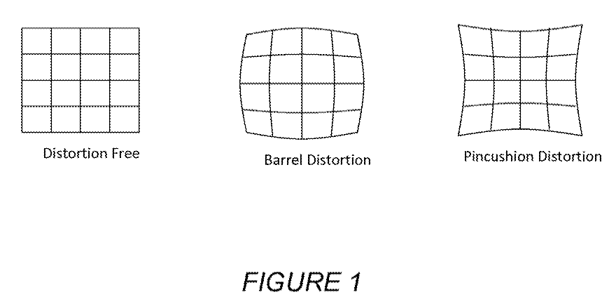

FIG. 2 shows an imaging system with a block for corrected geometric distortion, in accordance with prior art.

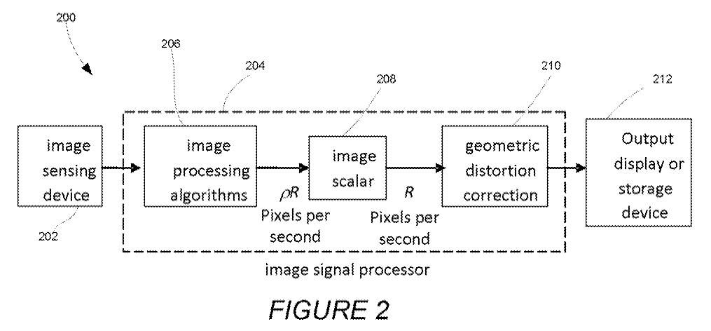

FIG. 3 shows the architecture of a geometric distortion correction block, in accordance with one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Although the following description contains many specifics for the purposes of illustration, one skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

As discuss earlier, a geometric distortion correction method operating on pipelined hardware must solve the memory bandwidth problem. Because of the structure of the image, adjacent pixels in the output image can be constructed (interpolated) using pixels from the input image within a small neighborhood. Furthermore, fetching pixels from a region in the input image is more efficient than fetching pixels on a one-by-one basis because we only need to set up the memory address once for all pixels on the same row. Therefore, memory bandwidth can be reduced by fetching a block of input data and generating output pixels a segment at a time.

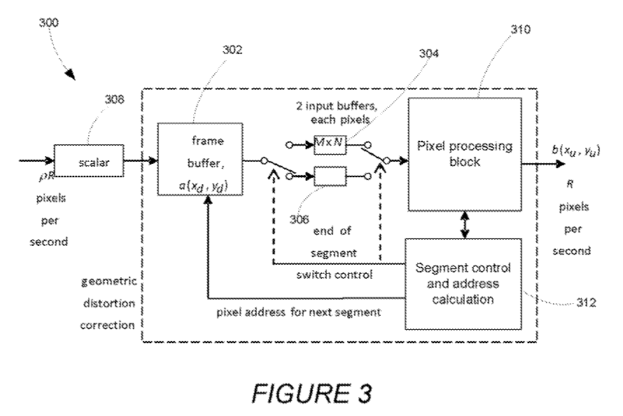

FIG. 3 of the drawings shows the architecture of a geometric distortion correction block 300 in accordance with one embodiment of the invention. In one embodiment, the architecture 300 replaces the block 210 in the system 200. As will be seen, the block 300 comprises a frame buffer 302 that in use is selectively connected or coupled to one of two input buffers designated a 304 and 306 in FIG. 3. The frame buffer 302 stores a geometrically distorted image a(x_{d}, y_{d}). from which the block 300 generates an output image b(xᵤ, yᵤ) that is corrected for geometric distortion, in accordance with the techniques disclosed herein.

To minimize memory bandwidth for accessing the frame buffer 302, the invention discloses a method that processes a 1×L segment of output pixels at a time. A scalar 308 is included in FIG. 3 to emphasize the difference in incoming data rate (pR pixels per second) and the output data rate (R pixels per second).

In one embodiment, the invention uses bilinear interpolation to generate an output pixel from the input pixel values. In this case a single output pixel will require a 2×2 block of input pixels, with the coordinates of the input and output pixels related by (3). Now consider a 1×L segment in the output image, i.e. L pixels in a row. From (3), we can determine the minimum rectangular block size m×n within the input image that would be required to produce the 1×L output segment. Since the extent of shift is non-uniform at different regions of the image, the values of m and n can change with respect to the location of the segment in the output image. Let M and N be the maximum value of m and n, respectively, where the maximum is taken over all possible location of the 1×L segment throughout the output image. For a given L value and a given distortion parameter λ in (3), it is straightforward to calculate the values of M and N. Generally, M and N increases when L increases, and also when the extent of the geometric distortion increases (|λ| increases).

The block 300 includes two switches that are connected so that one input buffer is connected to the frame buffer 302 and the other one is connected to a pixel processing block 310. The pixel processing block implements the particular algorithms or transformations to correct for geometric distortion. The buffer that is connected to the frame buffer 306 at any time is referred to as the receiving buffer, and the one that is connected to the pixel processing block 310 is referred to as the active data buffer. The output image is generated one segment at a time. While the output pixels in a segment is generated by interpolation using data in the active data buffer, the receiving buffer is fetching data from the frame buffer in preparation for the next segment. The processing is coordinated such that the time (number of clock cycles) required to process and send one segment of output pixel must be sufficient for reading all the input pixels required for the next segment. This can be ensured by considering the extent of distortion λ, the segment size 1×L, and the buffer size M×N.

Once the processing of a segment is completed, an end of segment signal is generated by a segment control and address calculation block 312. The end of segment signal causes a change in the connections and the roles of the two input buffers. That is, the active data buffer during processing of the previous segment becomes the receiving buffer, and the receiving buffer during processing of the previous segment becomes the active data buffer. The procedure continues one segment at a time until the entire output image has been generated.

The method described above uses input pixels in an M×N rectangular region to generate a 1×L segment of output pixels. Given a distortion parameter λ and a segment size L, it is straightforward to compute the minimum block size M×N required by the method. The problem can also be addressed in the opposite way. That is, one fixes the segment size L and the block size M×N, then determine the maximum extent of distortion that can be handled. If the distortion caused by the lens is more than the maximum extent allowed, then one can decrease L or increase the block size. Doing so may require slowing down the output.

In one embodiment, we let M=3 and N=L+3. That is, we want to ensure that any output segment of size 1×L can be generated using input pixels within a rectangular region of size no more than 3×(L+3). Obviously the smaller the L value, the extent of geometric distortion that can be corrected is bigger, i.e. the magnitude of λ in (3) that can be handled is bigger.

Consider an embodiment wherein the input image size is 3.15 million pixels (2048×1536 pixels), and the output size is 307 thousand pixels (640×480 pixels) for the preview mode. On the average, the system must be able to sustain a throughput of 3.15 million input pixels and 307 thousand output pixels on a continuous basis. Assume that there is one clock cycle available from hardware to send each pixel. For a segment of 1×L pixels, there are L>2048×1536/(640×480) or 10.24L clock cycles on the average to read the M×N block of input pixels.

If the frame buffer is organized in 16 bit wide, i.e. if the memory bus width is 16 bits, the number of clocks to read in a row of K pixels is

9+1.5(K−1)/2 or 8.25+0.75K.

In the first expression, 9 represents the memory address set up time, the factor 1.5 represents the number of memory reads per pixel (24 bits of data) where pixel values are bit packed in memory, and the factor 2 represents the ability to read twice within a clock cycle. Alternatively if the memory bus width is 32 bit wide, then the number of clocks to read a row of K pixels becomes

9+0.75(K−1)/2 or 8.625+0.375K.

The fundamental condition to be satisfied is that the time to read 3×(L+3) input pixels must be no more than 10.24L clock cycles. In an embodiment with 16 bit memory bus width, L must satisfy the inequality

3(8.25+0.75(L+3))≦10.24L

In other words, we need L≧4.

In another embodiment where the input image is decimated by a factor of 2 in each of the horizontal and vertical directions, i.e. the input image size is 750 thousand pixels (1024×768 pixels). This is a typical configuration in image capturing systems for supporting high preview frame rate. Using the same preview size of 307 thousand pixels, there are L×1024×768/(640×480) or 2.56L input clocks on the average to fill the input buffer. In this case, if we use memory with 16 bit bus width, the equality that must be satisfied is

3(8.25+0.75(L+3))≦2.56L.

In this case, we need L≧102. Although a solution exist, this is not practical because such a large value of L would mean that the extent of distortion that we can correct will be very small.

If we use memory with 32 bit bus width, then the equality becomes

3(8.625+0.375(L+3))≦2.56L.

In this example, we need L≧21.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principals of the present disclosure.

1. A method for correcting geometric distortion in an image, comprising:
operating at least first and second buffers upstream of a pixel processing block in pipelined hardware to each read M×N pixels of an input image to be corrected for geometric distortion;
selectively connecting one of the first and second buffers to the pixel processing block for inputting the M×N pixels contained therein to the pixel processing block; and
in the pixel processing block, processing the M×N input pixels to correct for geometric distortion, the processing block being configured to output segments 1×L pixels wide of an output image that is corrected for geometric distortion; wherein values for M and N are selected to define a minimum block size in the input image required to produce each current 1×L segment in the output image by an algorithm to correct for geometric distortion in the input image.

2. The method of claim 1, wherein a time taken to process each 1×L segment in the pixel processing block is sufficient to read the M×N pixels required for the next 1×L segment.

3. The method of claim 1, wherein selectively connecting one of the first and second buffers to the pixel processing block comprises after processing each 1×L segment in the pixel processing block, an end of segment signal is generated whereupon the buffer that was connected to the pixel processing block is connected to a frame buffer for reading the next M×N pixels of the input image; and the buffer that was connected to the frame buffer is connected to the pixel processing block for inputting the current M×N pixels to the pixel processing block.

4. The method of claim 3, wherein the selective connecting continues until all 1×L segments of the output image is produced.

5. An image signal processor, comprising:
at least first and second buffers, each to read M×N pixels of an input image to be corrected for geometric distortion;
a pixel processing block selectively connectable to each of the first and second buffers for receiving the M×N input pixels contained therein and to process the M×N pixels into a segment comprising 1×L pixels of an output image that is corrected for geometric distortion; wherein values for M and N are selected to define a minimum block size in the input image required to produce each current 1×L segment in the output image by an algorithm to correct for geometric distortion in the input image.

6. The image signal processor of claim 5, wherein each of the first and second buffers is selectively connectable to a frame buffer from which a current M×N block of input pixels required by the pixel processing block can be read.

7. The image signal processor of claim 6, wherein a time taken to process each 1×L segment in the pixel processing block is sufficient to read the M×N pixels required for the next 1×L segment from the frame buffer.

8. The image signal processor of claim 6, wherein an end of segment signal is generated upon completion of processing of a current M×N block of input signals by the pixel processing block.

9. The image processor of claim 8, wherein the end of segment signal causes a switching that results in the buffer that was connected to the pixel processing block to be disconnected therefrom and to be connected to the frame buffer, and the buffer that was connected to the frame buffer to be disconnected therefrom and to be connected to the pixel processing block.

10. The image signal processor of claim 9, wherein the switching continues until all pixels for the output image are generated.

11. An imaging system, comprising:
an image sensing device; and
an image signal processor coupled to the image sensing device, and comprising
at least first and second buffers, each to read M×N pixels of an input image to be corrected for geometric distortion;
a pixel processing block selectively connectable to each of the first and second buffers for receiving the M×N input pixels contained therein and to process the M×N pixels into a segment comprising 1×L pixels of an output image that is corrected for geometric distortion; wherein values for M and N are selected to define a minimum block size in the input image required to produce each current 1×L segment in the output image by an algorithm to correct for geometric distortion in the input image.

12. The imaging system of claim 11, wherein each of the first and second buffers is selectively connectable to a frame buffer from which a current M×N block of input pixels required by the pixel processing block can be read.

13. The imaging system of claim 12, wherein a time taken to process each 1×L segment in the pixel processing block is sufficient to read the M×N pixels required for the next 1×L segment from the frame buffer.

14. The imaging system of claim 12, wherein an end of segment signal is generated upon completion of processing of a current M×N block of input signals by the pixel processing block.

15. The imaging system of claim 14 wherein the end of segment signal causes a switching that results in the buffer that was connected to the pixel processing block to be disconnected therefrom and to be connected to the frame buffer, and the buffer that was connected to the frame buffer to be disconnected therefrom and to be connected to the pixel processing block.

16. The imaging system of claim 15, wherein the switching continues until all pixels for the output image are generated.
